(19) United States
(12) Patent Application Publication
(10) Pub. No.: US 2014/0202550 A1
(43) Pub. Date: Jul. 24, 2014

(54) PRESSURE RELIEF VALVE

(71) Applicant: Kenneth A. Watson, Vancouver, WA (US)

(72) Inventor: Kenneth A. Watson, Vancouver, WA (US)

(21) Appl. No.: 13/872,808

(22) Filed: Apr. 29, 2013

Related U.S. Application Data
(60) Provisional application No. 61/756,766, filed on Jan. 25, 2013.
(60) Provisional application No. 61/734,765, filed on Dec. 7, 2012.

(51) Int. Cl. B60K 15/035

(52) U.S. Cl. CPC B60K 15/03519
USPC 137/12; 137/899

(57) ABSTRACT

A pressure relief valve and a mating fuel tank bung are installed directly on a fuel tank. In one embodiment a bung is welded directly to a fuel tank, and thereafter a pressure relief valve is attached directly to the bung by mating threads. This system and installation method provides a cost and time effective installation process that is expedient, does not require additional pipes or plumbing fixtures, and the resulting installed valve may provide improved safety features due to the exclusion of additional pipes and plumbing positioned between the valve and the fuel tank and a compactness of design.

This application claims priority on U.S. provisional patent application Ser. No. 61/756,766, filed on Jan. 25, 2013, and claims priority on U.S. provisional patent application Ser. No. 61/734,765, filed on Dec. 7, 2012, both entitled PRESSURE RELIEF VALVE.

### TECHNICAL FIELD

The present invention relates to a high flow pressure relief valve and a process for installing the same, for use in commercial vehicles, for example, and more particularly, to a high flow pressure relief valve that may be installed directly on a fuel tank without additional plumbing positioned between the valve and the tank.

### BACKGROUND OF THE INVENTION

The present invention is particularly intended for use on commercial vehicles, although it may be used with any internal combustion engine connected to a fuel tank. In one particular application, LNG (Liquefied Natural Gas) trucks have one tank for holding natural gas and one smaller tank for holding the diesel used on the LNG truck. LNG engine manufacturers may desire a safety relief valve on the diesel tank to protect the diesel tank if accidental transfer of high pressure from the LNG tank occurs. Such a transfer of high pressure could occur if a pressure seal inside the LNG engine fails. A flow specification of this relief valve might be a flow rate as high as 3,000 standard cubic feet per hour (SCFH) which would prevent rupture of the diesel tank upon occurrence of the accidental transfer of high pressure from the LNG tank. Prior art pressure relief valves are mounted separately from the fuel tank and then plumbed to the fuel tank with hoses and fittings positioned between the valve and the tank. This remote installation of a valve is time intensive and costly and requires more space on the vehicle on which the assembly is installed. There is a need therefore for a safety valve that provides for a high flow rate and which is less time intensive and less expensive to install and which includes a more compact design.

### SUMMARY OF THE INVENTION

The present invention provides a pressure relief valve and a mating fuel tank bung which are installed directly on a fuel tank, and a process of installing the same. One aspect of the present invention provides a pressure relief valve bung that is welded directly to the tank, and thereafter a pressure relief valve is attached directly to the bung by mating threads. This system and installation method provides a cost savings over prior art devices because the installation process is expedient, no additional plumbing is required, and the resulting installed valve may include additional safety features compared to prior art valves due to the exclusion of additional plumbing positioned between the valve and the fuel tank of the present invention. The present invention is compact and provides for safety release flow rates that meet desired specifications.

### BRIEF DESCRIPTION OF THE DRAWINGS

FIG. 1 is a top view of one example embodiment of a pressure relief valve.

FIG. 2 is a side cross-sectional view of the valve of FIG. 1 in an unpressurized condition.

FIG. 3 is a side cross-sectional view of the valve of FIG. 1 in a pressurized condition and mounted on a bung secured to a fuel tank.

FIG. 4 is a side view of one example embodiment of a fuel tank bung shown in FIG. 3.

FIG. 5 is a top view of the bung of FIG. 4.

FIG. 6 is top view of another example embodiment of a pressure relief valve.

FIG. 7 is a side cross-sectional view of the valve of FIG. 6 in a non-roll over position and a non-thermal relief position.

### DETAILED DESCRIPTION OF THE PREFERRED EMBODIMENTS

The invention discloses a pressure relief valve that is intended for use on commercial vehicles, although it may be used with any internal combustion engine connected to a fuel tank.

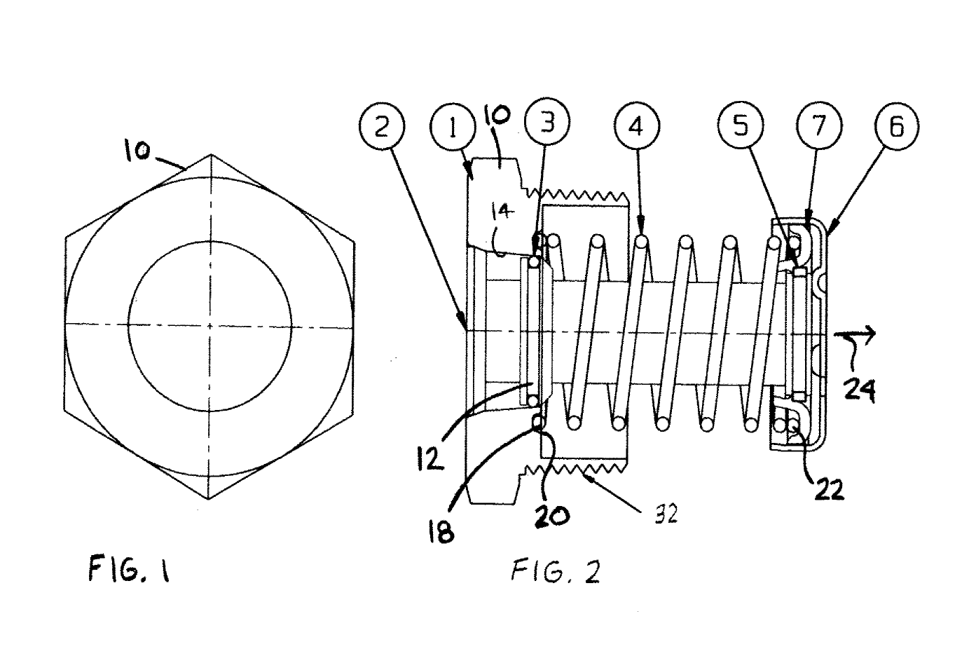

FIG. 1 is a top view of one example embodiment of a pressure relief valve 10.

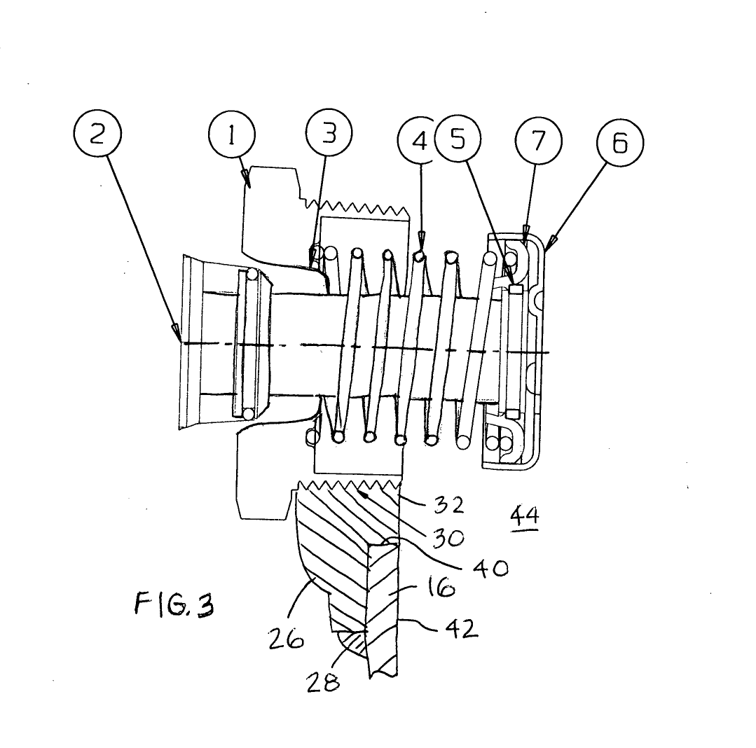

FIG. 2 is a side cross-sectional view of the valve 10 of FIG. 1 in an unpressurized condition. Valve 10, in the embodiment shown, includes a valve body 1, a full function vent 2, such as a slidable shaft, a sealing member 3, such as an O-ring, a biasing member 4, such as a coil spring, a thermal relief member 5, such as a thermal relief ring manufactured of a temperature dependent deformable material, a spring capture structure 6, such as a baffle, and a second spring capture structure 7, such as a cup washer. Valve body 1, in one example embodiment, may be a 1½ PTF. In other embodiments, other sizes of valve body 1 may be utilized. O-ring 3 is positioned within a groove 12 of slidable shaft 2 and in an unpressured condition of the valve 10, as shown in FIG. 1, the O-ring 3 seals against an interior surface 14 of valve body 1 to seal a fuel tank 16 (FIG. 3) from leakage or spillage of fuel there from. A first end 18 of coil spring 4 is seated within a groove 20 of valve body 1 and a second end 22 of coil spring 4 is secured within cup washer 7 of baffle 6 by thermal relief ring 5. In an unpressured condition of fuel tank 16 (FIG. 3), coil spring 4 will tend to bias baffle 6 away from valve body 1 in a direction 24 until spring 4 is positioned in a its nominal, unpressurized condition. In this unpressurized position, O-ring 3 will seal valve 10, thereby sealing fuel tank 16 (FIG. 3) from leakage or loss of fuel through the valve body 1.

FIG. 3 is a side cross-sectional view of the valve 10 of FIG. 1 in a pressurized condition and mounted on a bung 26 secured to a fuel tank 16, such as with a weld 28. Other securement mechanisms may be utilized to secure bung 26 to fuel tank 16. Bung 26 may include securement structure 30, such as internal threads, that may mate with securement structure 32, such as internal threads, to quickly and easily secure pressure relief valve 10 on bung 26. A sealing tape, not shown, may be placed around threads 32 of valve 10 prior to securement on threads 30 so as to render the connection between threads 30 and 32 air tight and fluid tight.

In a pressured condition of fuel tank 16, such as at pressures in a range of approximately 6.8 to 8.5 pounds per square inch (psi), as one example, the pressure on slidable shaft 2 may force slidable shaft to begin to move in a direction 34 such that a top portion 36 of slidable shaft 2 is moved away from contact with interior surface 14 of valve body 1, which may allow pressurized air to escape through valve 10 between top portion 36 of slidable shaft 2 and interior surface 14 of valve body 1. At pressures in a range of 10.0 to 15.0 psi, for example, the slidable shaft 2 may be completely clear of interior surface 14 so that the valve 10 may be referred to as completely open, thereby allowing a relatively large flow of pressurized air and/or fluid to escape through valve 10 between top portion 36 of slidable shaft 2 and interior surface 14 of valve body 1, such as allowing a flow rate of 3,000 SCFH, with a maximum back pressure of 13 psi, for example. Such a flow rate of 3,000 SCFH, for example, may prevent rupture of the diesel tank upon pressurization of the fuel tank in the case of an accidental transfer of high pressure from the LNG tank to the fuel tank 16.

In this pressurized condition, as slidable shaft 2 is moved in direction 34, coil spring 4 is compressed thereby drawing baffle 6 and cup washer 7 closer toward valve body 1 in direction 34. Even in a fully pressurized condition wherein coil spring 4 is completely compressed, the spring will normally space baffle 6 a sufficient distance from valve body 1 such that pressured air and/or fluid may still exit the fuel tank 16 through valve body 1 and around top portion 36 of slidable shaft 2.

Pressure relief valve 10 further includes thermal relief ring 5, such as a lead or a silver ring that will deform, such as by melting, for example, at a temperature of approximately 225 degrees Fahrenheit or higher, for example. The deformation of ring 5 may allow bottom portion 38 of slidable shaft 2 to be released from baffle 6 and cup washer 7, thereby allowing shaft 2 to slide freely from valve body 1 and release pressure from fuel tank 16 without compression of coil spring 4. Once slidable shaft 2 is released from baffle 6 and cup washer 7 by activation of thermal relief ring 5, spring 4, baffle 6 and cup washer 7 may no longer be connected to valve body 1 and thereafter spring 4, baffle 6 and cup washer 7 may fall downwardly into an interior the fuel tank 16, further allowing a quick release of pressure through pressure relief valve 10.

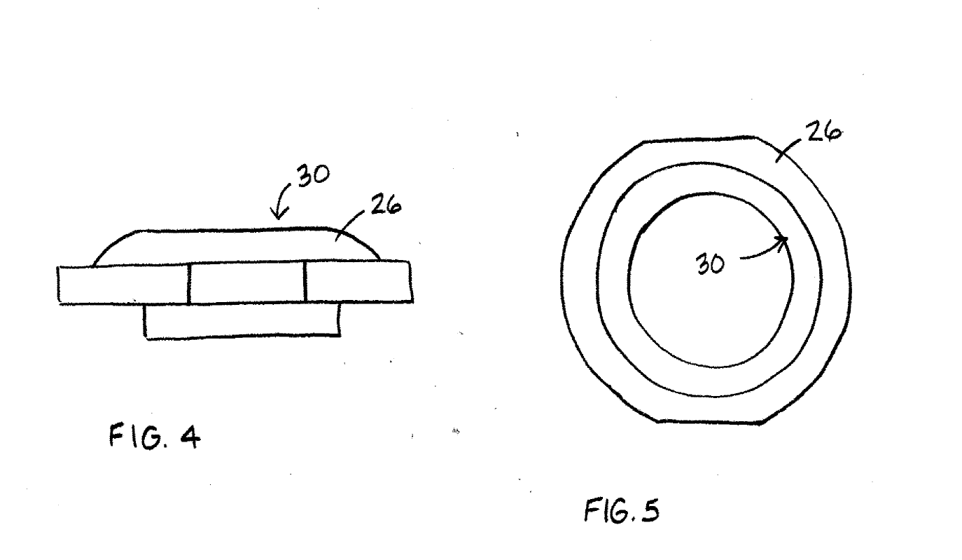

FIG. 4 is a side view of one example embodiment of a fuel tank bung 26 shown in FIG. 3. Referring to FIGS. 3 and 4, bung 26 may be secured to an aperture 40 within a wall 42 of fuel tank 16 by any means for a particular application, such as with a weld 28. Valve body 1 may then be secured within bung 26 by mating bung threads 30 and valve body threads 32.

In this manner valve body 1 is secured directly on fuel tank 16 such that a portion of coil spring 4 and an entirety of baffle 6 and cup washer 7 are positioned within an interior 44 of fuel tank 16. Moreover, due to this direct installation of pressure relief valve 10 on fuel tank 16, there are no pipes or other plumbing fixtures positioned between valve 10 and fuel tank 16, thereby eliminating safety defects in the present invention that may have been related to such prior art pipes or plumbing fixtures. Moreover, due to this direct installation of pressure relief valve 10 on fuel tank 16, installation costs and component costs are reduced because such prior art pipes and plumbing fixtures need not be purchased or installed in the present inventive installation method. Furthermore, the direct installation process of the present invention results in a more compact size pressure relief valve that requires less space than prior art valves, which included additional pipes and plumbing fixtures.

FIG. 5 is a top view of the bung 26 of FIG. 4.

FIG. 6 is top view of another example embodiment of a pressure relief valve 10. In this embodiment, valve body 1 includes a barb 11 which includes a vent aperture 46 extending there through and communicating with an interior of slidable shaft 2.

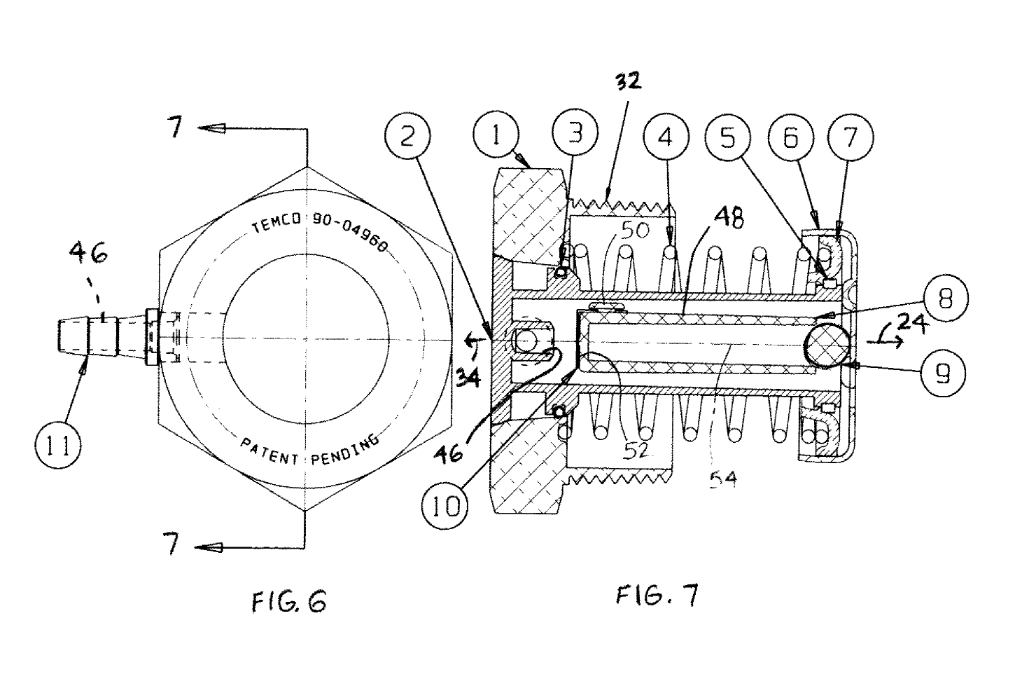

FIG. 7 is a side cross-sectional view of the valve of FIG. 6, taken along line 7-7, in a non-roll over position and in a non-thermal relief position. In this non-thermal relief position, thermal ring 5 is still intact, and has not been deformed by high temperatures within a fuel tank on which pressure relief valve 10 is installed. Accordingly, in this position thermal relief ring 5 secures slidable shaft 2 to baffle 6 and cup washer 7.

In this non-roll over position, valve body 1 is positioned vertically above baffle 6 and cup washer 7, as measured in direction 34, such that gravity forces a float 8, such as a float manufactured of a plastic material, and a ball 9, such as a stainless steel ball, downwardly and away from valve body 1 and aperture 46, in downward direction 24. Float 8 includes a seal 10 secured to a side surface 48 of float 8 by a projection 50 and extending over a top surface 52 of float 8. In this non-roll position, seal 10 does not block fluid, air or other gases, from venting through vent aperture 46 in valve body 1 and outwardly to the atmosphere through barb 11.

In a roll over position, such as when a truck and/or a tank to which pressure relief valve 10 is secured, rolls over, such as during an accident, valve body 1 may be positioned other than vertically upright. In particular, in such a roll over position, an axis 54 of relief valve 10 may not be positioned vertically but may be positioned at an angle to vertical, such that baffle 6 and cup washer 7 may be positioned upwardly of or vertically above valve body 1. In such a position, gravity may force float 8 downwardly in a direction 34 such that seal 10 seals against aperture 46, thereby preventing leakage of fuel and/or gases through aperture 46 of relief valve 10, and possibly preventing a fire due to fuel leakage. Float 8 and seal 10 may be held securely against aperture 46 in this position by the downward force of gravity on float 8 and on ball 9, which will force float 8 against aperture 46, wherein ball 9 may be made of a heavily weighted material, such as stainless steel.

Accordingly, there is provided a high flow, pressure relief valve 10 that also allows thermal relief venting during high temperatures in a fuel tank, wherein ring 5 deforms, and also inhibits leakage of fuel during roll-over situations, such that fuel does not leak from a fuel tank during an accident, due to movement of float 8. All of these functions are preformed by compact, sturdy, easily installed relief valve 10.

In the above description numerous details have been set forth in order to provide a more through understanding of the present invention. It will be obvious, however, to one skilled in the art that the present invention may be practiced using other equivalent designs.

I claim:

1. A fuel tank comprising:
a fuel tank body including a wall having an aperture extending there through;
a valve securement structure secured directly to said wall at said aperture; and
a valve secured to said securement structure and extending through said aperture, said valve including a fuel release opening sized to allow a flow rate there through of at least 3,000 SCFH.

2. The fuel tank of claim 1 wherein said valve includes a valve body that defines said fuel release opening, said valve further including a shaft slidably positioned within said valve body for movement through said valve body between a closed position and an open position of said fuel release opening.

3. The fuel tank of claim 2 wherein said fuel release opening defines a tapered interior surface of said valve body, and wherein said shaft includes a tapered exterior surface that mates with said tapered interior surface of said valve body in said closed position.

4. The fuel tank of claim 3 wherein said tapered exterior surface of said shaft is moved outwardly of said tapered interior surface of said valve body in said open position.

5. The fuel tank of claim 2 wherein said shaft includes a first end region positioned within said valve body and a second end region positioned opposite from said first end region, said valve further including a baffle, a cup washer positioned within said baffle, and a thermal relief ring that secures said second end region of said shaft in said cup washer in a normal thermal condition.

6. The fuel tank of claim 5 wherein said thermal relief ring is manufactured of a material that deforms at a predetermined temperature to form a deformed thermal relief ring, and wherein said deformed thermal relief ring allows said second end region of said shaft to be removed from securement from said cup washer.

7. The fuel tank of claim 6 wherein said valve further includes a biasing structure having a first end region positioned on said valve body, a second end region positioned on said cup washer and said biasing structure biasing said cup washer away from said valve body during an unpressurized condition within said fuel tank.

8. The fuel tank of claim 7 wherein said shaft is moved to said open position during a pressurized condition within said fuel tank, and wherein movement of said shaft to said open position moves said biasing structure from a nominal position in said unpressurized condition within said fuel tank to a compressed position during said pressurized condition within said fuel tank.

9. The fuel tank of claim 8 wherein said shaft includes a side wall having a shaft aperture extending there through and said shaft includes a hollow interior that communicates with said shaft aperture, said valve further including a movable structure positioned within said hollow interior, said movable structure manufactured of a material that floats in fuel, wherein said movable structure seals said shaft aperture when said valve is in a tipped position.

10. The fuel tank of claim 9 wherein said movable structure is positioned out of contact with said shaft aperture when said valve is in an untipped position.

11. The fuel tank of claim 9 wherein said valve further includes a weight structure positioned within said hollow interior, said weight structure holding said movable structure in contact with said shaft aperture in said tipped position.

12. The fuel tank of claim 9 wherein said movable structure includes a seal secured thereon.

13. The fuel tank of claim 7 wherein said biasing structure comprises a coil spring that coils around said shaft.

14. The fuel tank of claim 1 wherein said valve is secured to said securement structure by a securement device chosen from the group consisting of mating threads, a weld, adhesive, and a snap fitting.

15. A fuel tank comprising:
a fuel tank body including a wall having an aperture extending there through; and
a valve positioned within said aperture, said valve including a fuel release opening sized to allow a flow rate there through of at least 3,000 SCFH.

16. The fuel tank of claim 15 wherein said valve includes a valve body that defines said fuel release opening, said valve further including a shaft slidably positioned within said valve body for movement through said valve body between a closed position and an open position of said valve.

17. The fuel tank of claim 16 further including a thermal relief element that releases said shaft from securement within said valve body at a predetermined temperature.

18. A method of venting pressure from a fuel tank, comprising:
providing a fuel tank including a fuel tank wall having an aperture extending there through;
securing a valve body within said aperture, said valve body defining a fuel release opening extending there through;
slidably securing a shaft within said fuel release opening of said valve body, said shaft biased into a closed position within said fuel release opening in a non-pressurized condition of said fuel tank and said shaft moved into an open position at least partially outwardly of said fuel release opening in a pressurized condition of said fuel tank.

19. The method of claim 18 further including thermal relief venting of said fuel tank, comprising:
securing an end of said shaft within a retainer structure with a thermal relief material, said thermal relief material securing said end of said shaft in said retainer structure at temperatures below a predetermined temperature, and said thermal relief material deforming at said predetermined temperature so as to release said end of said shaft from said retainer structure, wherein said release of said end of said shaft from said retainer structure allows movement of said shaft from said fuel release opening.

20. The method of claim 18 further including roll over protection of said fuel tank, comprising:
securing a movable float within said shaft, said float moved into in a sealing position within said shaft in a tipped condition of said fuel tank, and said float moved into a non-sealing position within said shaft in an untipped condition of said fuel tank.
